(19) United States
(12) Patent Application Publication
(10) Pub. No.: US 2009/0040090 A1
(43) Pub. Date: Feb. 12, 2009

(54) CONTROL PANEL FOR CONTROLLING A DOMESTIC APPLIANCE

(75) Inventors: Uwe Hahn, Guetersloh (DE); Horst Noeller, Guetersloh (DE); Claudia Scholt, Bielefeld (DE)

Correspondence Address: DARBY & DARBY P.C., P.O. BOX 770, Church Street Station, New York, NY, 10008-0770, US

(73) Assignee: MIELE & CIE. KG, Guetersloh (DE)

(21) Appl. No.: 11/573,960

(22) PCT Filed: Aug. 13, 2005
(86) PCT No.: PCT/EP05/08828

§ 371 Date: Feb. 20, 2007

(30) Foreign Application Priority Data
Aug. 27, 2004 (DE) 10 2004 041 527.7

(51) Int. Cl. H04L 17/02

(52) U.S. Cl. 341/173

(57) ABSTRACT

A control panel for controlling a household appliance includes a housing and an electric or electronic controller disposed in the housing. The controller includes a processing unit and a memory. A first control element is disposed on the housing and electrically connected to the controller. A second control element is disposed on the housing and is electrically connected to the controller. The second control element includes a ten-digit keypad. A light source is provided that is activatable by the first control element and for illuminating the keypad in accordance with a predetermined activation condition stored in the memory. The light source is electrically connected to the controller. When the light source is deactivated, the keypad and light source are substantially invisible to the human eye.

### CROSS REFERENCE TO PRIOR APPLICATION

This is a U.S. national phase application under 35 U.S.C. §371 of International Patent Application No. PCT/EP2005/008828, filed Aug. 13, 2005, and claims benefit of German Patent Application No. 10 2004 041 527.7, filed Aug. 27, 2004, which is incorporated by reference herein. The International Application was published in German on Mar. 9, 2006 as WO 2006/024385 A1 under PCT Article 21(2).

The present invention relates to a control panel for controlling a controller of a household appliance including a housing on which are mounted a group of first control elements and a group of second control elements, and including a light source for illuminating the group of second control elements.

### BACKGROUND

A control panel for controlling a controller of a household appliance is described, for example, in German Patent DE 198 32 757 C2. The known control panel for controlling a cooking appliance controller includes a housing on which are mounted a group of first control elements and a group of second control elements. Moreover, the known control panel is provided with a light source for illuminating a second control element. The first and second control elements and the light source are electrically conductively connected to a controller which is disposed in the housing and is in the form of an electronic controller and which includes a processing unit and a memory.

The illuminable second control element and the light source are configured and disposed on the housing in such a way that when the light source is deactivated, said control element and light source are substantially invisible to the human eye, and that the light source can be activated by actuating a first control element.

The backlighting of control elements is also the subject matter of DE 199 18 290 C1. The selector elements disclosed therein for selecting a cooking zone are backlit to indicate the active cooking zones.

Furthermore, German Patent Application DE 102 36 718 A1 describes a control panel for a household appliance, said control panel having a special light-transmitting section.

German documents DE 31 33 176 C1 and DE 30 10 715 A1 describe keypads in the form of ten-digit keypads.

### SUMMARY

In view of the above, it is an object of the present invention to provide a control panel with less complex circuitry and simple construction that is easier to use and has an improved overall aesthetic appearance.

The present invention provides a control panel for controlling a household appliance. The control panel includes a a housing and an electric or electronic controller disposed in the housing. The controller includes a processing unit and a memory. A first and a second control element are disposed on the housing and electrically connected to the controller. The second control element includes a ten-digit keypad. A light source is included that is activatable by the first control element and configured to illuminate the keypad in accordance with a predetermined activation condition stored in the memory. The light source is electrically connected to the controller. When the light source is deactivated, the keypad and light source are substantially invisible to the human eye.

### BRIEF DESCRIPTION OF THE DRAWINGS

An exemplary embodiment of the present invention is shown in the drawings in a schematic way and will be described in more detail below. In the drawings,

FIG. 1 is a view showing a household appliance in the form of a baking oven having a control panel according to the present invention, looking at the front of the control panel;

FIG. 2 is an exploded view of the control panel of FIG. 1, looking at the rear thereof,

FIG. 3 is a detail view of the control panel of FIG. 1, showing the ten-digit keypad in an unilluminated state;

FIG. 4 is a view of the control panel similar to that of FIG. 3, showing the ten-digit keypad in an illuminated state;

FIG. 5 is a view of the control panel similar to that of FIG. 3, showing the ten-digit keypad in an unilluminated state;

FIG. 6 is a top view of a household appliance in the form of a stand-alone cooktop having a control panel according to the present invention, showing the ten-digit keypad in an unilluminated state; and

FIG. 7 is a view of the cooktop identical to that of FIG. 6, but showing the ten-digit keypad in an illuminated state.

### DETAILED DESCRIPTION

Besides reducing the complexity of the construction and circuitry, the present invention provides the additional advantage of improving the ease of use and the overall aesthetic appearance. The ten-digit keypad is visible to the user only when it is needed to enter numerical information, for example, to enter a cooking temperature or a cooking time for a cooking process taking place within a cooking appliance. Otherwise, the ten-digit keypad is substantially invisible to the human eye. On the one hand, this prevents control elements that are currently not needed from distracting the user during the entry of control information to the household appliance. This improves the clarity of the control panel of the present invention. On the other hand, the control panel of the present invention allows for increased freedom of design and, thus, for improved matching of the visual design of the control panel to that of the household appliance as a whole.

In a particularly advantageous refinement of the teaching of the present invention, the illumination of the ten-digit keypad is designed as backlight illumination. Thus, the control panel of the present invention can be implemented in a particularly simple manner.

In a further advantageous refinement, different illumination modes for illuminating the ten-digit keypad are stored in the memory and can be selected and activated by the processing unit in accordance with the actuated first control element or a program which is stored in the memory and can be invoked by means of the processing unit for the operation of the household appliance. In this manner, the overall aesthetic appearance and the ease of use are further improved.

In an advantageous refinement of the aforementioned embodiment, the different illumination modes can be produced by a light source having a plurality of light-emitting diodes. Thus, the different illumination modes can be implemented in a particularly simple and inexpensive manner.

According to another advantageous embodiment, the processing unit includes a first timer which can be activated by activation of the light source and which allows the light source to be automatically deactivated after a predetermined first period of time stored in the memory has elapsed. This further improves the ease of use.

In an advantageous refinement of the aforementioned embodiment, the activated first timer can be deactivated in accordance with a predetermined first deactivation condition stored in the memory. This ensures that the ten-digit keypad remains visible to the human eye until the user has completed entering the required numerical information via said keypad.

According to an advantageous refinement of the aforementioned embodiment, the processing unit includes a second timer which can be activated when the first deactivation condition is satisfied and which allows the light source to be automatically deactivated after a predetermined second period of time stored in the memory has elapsed. This ensures that the illumination of the ten-digit keypad is automatically deactivated after a maximum time period has elapsed.

The control panel according to the present invention can, in principle, be designed as a remote control or as an independent unit. Conveniently, the control panel is incorporated into a household appliance, and thus structurally integrated therewith.

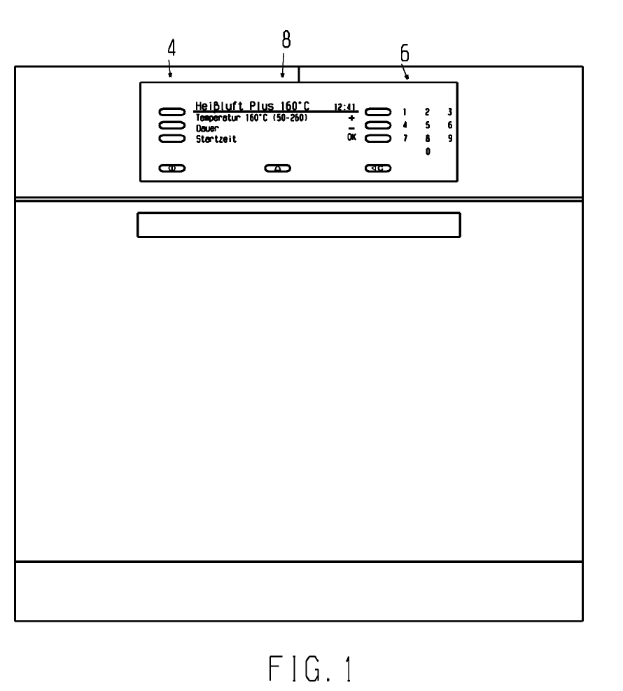

FIG. 1 shows a household appliance according to the present invention in the form of a baking oven, including a control panel according to the present invention. The household appliance, including the control panel, is illustrated in a front view. The control panel for controlling a controller (not shown in FIG. 1) of the household appliance includes a group of first control elements 4 and a group of second control elements 6, the group of second control elements 6 being in the form of a ten-digit keypad. First and second control elements 4 and 6 are designed as touch-sensitive membrane keys. The group of first control elements 4 has imprinted on the control panel a border that is perceptible to the human eye. In FIG. 1, ten-digit keypad 6 is shown in an illuminated state, so that it is perceptible to the human eye. A display element 8 in the form of a graphics display is located between the two groups of control elements 4 and 6.

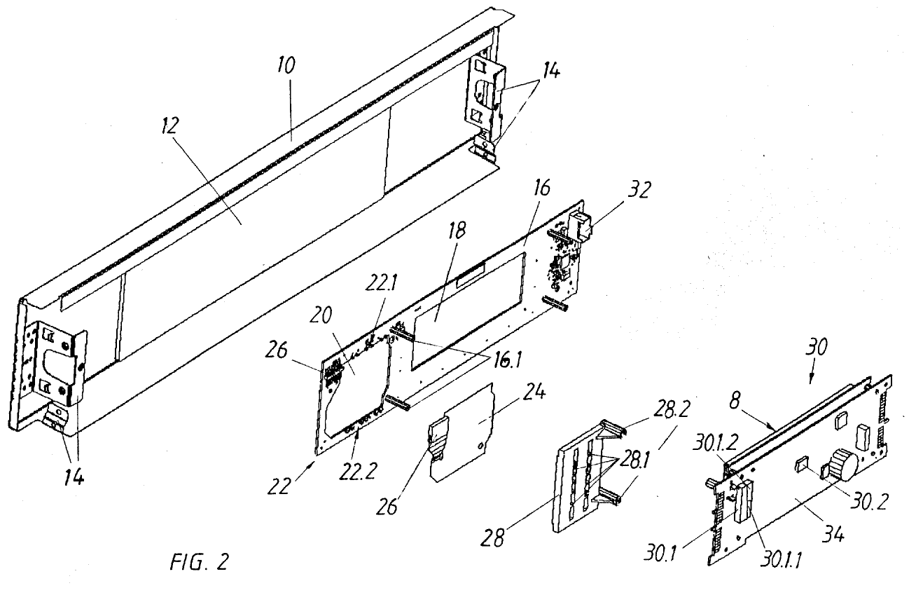

In FIG. 2, the control panel of the present invention is shown in an exploded view, looking at the rear thereof. The control panel according to the present invention has a housing 10 in which an opening 12 is formed approximately centrally therein. Housing 10 is provided with angular mounting brackets 14 at both lateral ends thereof for attachment of housing 10, and thus of the whole control panel, to the body of the household appliance (not shown in FIG. 2).

Furthermore, the control panel of the present invention has a frame member 16 which is in the form of a circuit board and surrounds a first opening 18 and a second opening 20. Frame member 16 has formed thereon two projections 16.1, whose function will be explained hereinafter. Frame member 16 has disposed thereon light source 22 and the control element control circuitry for the two groups of control elements 4 and 6. Light source 22 is designed as an upper row 22.1 of a total of six light-emitting diodes and a lower row 22.2 of a total of six light-emitting diodes. The two rows 22.1 and 22.2 are arranged on frame member 16 along the upper and lower edges of opening 20 in three groups of two, respectively, and electrically conductively connected to the control element control circuitry for the two groups of control elements 4 and 6. The frame member is dimensioned to completely cover the opening 12 in housing 10, when the control panel is in the assembled condition.

In the assembled condition of the control panel, opening 20 in frame member 16 is covered by a transparent, touch-sensitive membrane 24, said membrane 24 being electrically conductively connected to frame member 16 by plug contacts 26. Membrane 24 is dyed black such and is substantially nontransparent and has arranged thereon the numbers 0 through 9 in the manner of a ten-digit keypad 6, said numbers being provided as transparent regions of membrane 24 in a manner known to those skilled in the art (see also FIG. 4). A frame-shaped light guide 28 is disposed directly behind membrane 24, as viewed in a direction opposite to the direction of the view. In the assembled condition of the control panel according to the present invention, when light source 22 is activated, the light emitted by the light source is simultaneously coupled into light guide 28 at the lower and upper edges thereof in a manner known to those skilled in the art, passed through light guide 28, and coupled out at light-output locations disposed on the front face of light guide 28. In the assembled condition of the control panel, the light-output locations of light guide 28 are located directly behind the individual digits 0 through 9, which are provided as transparent regions of membrane 24. The regions of light guide 28 which, in the assembled condition of the control panel, are not located directly behind one of digits 0 through 9 of membrane 24 are substantially reduced to lands of material. Moreover, light guide 28 is provided with a sleeve-shaped holder 28.2 at each of its upper and lower ends. In the assembled condition of the control panel, said sleeve-shaped holders cooperate with projections 16.1 in a manner known to those skilled in the art, thereby securing light guide 28 on frame member 16.

Controller 30 is designed as an electronic controller which, in the assembled condition of the control panel, is electrically conductively connected to the control element control circuitry formed on frame member 16 via plug contacts 32 (only partially shown) for purposes of processing the signals from control elements 4 and 6 and the control thereof. Controller 30 further includes a memory 30.2 and a processing unit 30.1 in the form of a microprocessor. Controller 30 and display element 8, which is dyed black, are disposed on a circuit board 34 in a manner known to those skilled in the art.

During the assembly of the control panel of the present invention, first the membrane 24 is plugged onto frame member 16 by means of plug contacts 26, and is thereby electrically conductively connected to the control element control circuitry. After that, frame member 16, together with the membrane 24 secured thereto, is attached by gluing to housing 10 of the control panel. Light guide 28 is inserted by means of sleeve-shaped holders 28.2 onto projections 16.1 formed on frame member 16, and is thereby secured on frame member 16. Finally, controller 30 is attached to frame member 16 in a manner known to those skilled in the art, such that display element 8 completely covers first opening 18 of frame member 16.

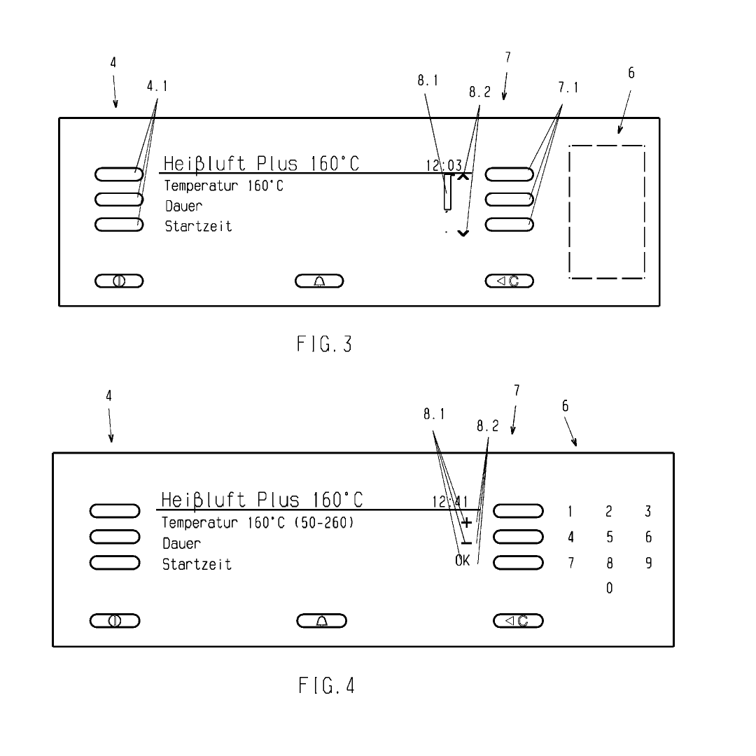

In the following, the operation of the control panel of the present invention will be explained in greater detail with reference to FIGS. 3 through 5.

In FIG. 3, the control panel of the present invention is shown with ten-digit keypad 6 in an unilluminated state. It can be clearly seen in FIG. 3 that ten-digit keypad 6, symbolized in FIG. 3 as a dashed line, is imperceptible to the human eye when in the unilluminated state. Due to the white borders 4.1 imprinted on the black background of the control panel, the group of first control elements 4 is readily perceptible to the human eye in both the ON and OFF states of the household appliance. To ensure the reproducibility of the drawing of the present application, the black background and the white borders 4.1 are shown inverted in FIG. 3. In the uppermost line of display element 8, the text “Hot air plus 160° C.” is displayed on the left and “12 03” is displayed on the right. The information displayed indicates that the cooking program “Hot air plus” has been selected by the user on the household appliance, which is in the form of a baking oven. The factory-preprogrammed oven chamber temperature for the selected cooking program is 160° C. The current time is 12:03 hours. Furthermore, the individual control elements of the group of first control elements 4 have textual displays associated therewith on display element 8, namely “Temperature 160° C.”, “Duration”, and “Start time”.

The graphics-capable display element 8 also allows for display of pictorial information, as illustrated in FIG. 3 on the right of display element 8. In addition to a bar graph 8.1 and orientation arrows 8.2 displayed there for easier control, additional control elements 7 are provided which are associated with the orientation arrows 8.2 and are also clearly marked by imprinted white borders. Analogously to borders 4.1 in FIG. 3, these borders are also shown inverted. Depending on whether the additional control element 7 associated with the upper orientation arrow 8.2 in the image plane is actuated or whether that associated with the lower orientation arrow 8.2 in the image plane is actuated, the white portion of bar graph 8.1 changes in a manner known to those skilled in the art. Analogously to the borders, bar graph 8.1 is represented by a black border.

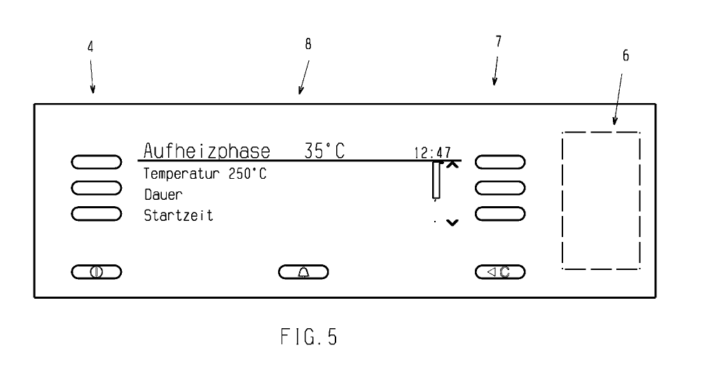

When the user actuates, for example, the first control element of the group of first control elements 4, which first control element is shown at an upper position in the image plane, then light source 22 is activated and ten-digit keypad 6 is backlit (see FIG. 4). The digits 0 through 9 become visible to the human eye on the front of the control panel, which faces the user. By using the now visible digits 0 through 9, the user can change the oven chamber temperature for the selected cooking process in steps of 1° C. from the default temperature of 160° C. (now backlit in white) to any temperature between 50° C. and 260° C. The default temperature is also shown inverted, i.e., in black. The range of values for the selectable baking oven temperature is also displayed on display element 8. Furthermore, a different function is now associated with the additional control elements 7, which can also be clearly seen from the difference in the display on the right of display element 8. Instead of bar graph 8.1 and orientation arrows 8.2 shown in FIG. 3, other symbols are now associated with the additional control elements 7 on display 8, namely “+” with the upper one, “−” with the middle one, and “OK ” with the lower one of said additional control elements 7. Once the user has set the desired oven chamber temperature and confirmed it by pressing on the additional control element 7 located at a lower position in the image plane, the so-selected oven chamber temperature, for example 250° C., is accepted for the previously selected cooking program (see FIG. 5). Alternatively, the user can also select and confirm the oven chamber temperature using only the additional control elements 7.1. In this case, the procedure is analogous to the control steps previously explained with reference to FIGS. 3 and 4.

As already explained with reference to FIG. 4, FIG. 5 shows the control panel of the present invention after confirmation of the oven chamber temperature set by means of ten-digit keypad 6. Since the setting of the oven chamber temperature has been completed and ten-digit keypad 6 is therefore no longer needed, light source 22 is deactivated again and ten-digit keypad 6 is no longer backlit. Ten-digit keypad 6 is no longer visible to the human eye, and the appearance of the control panel of the present invention is similar to that shown in FIG. 3. Analogously to FIG. 3, ten-digit keypad 6 is symbolized by a dashed line.

The user is further able to change or specify the cooking time and the start time for the selected cooking program. To do this, the user actuates the respective control element of the group of control elements 4 which control element is associated with the corresponding textual display “Duration” or “Start time”. The further procedure is analogous to the explanations given hereinabove.

In the present exemplary embodiment, processing unit 30.1 of controller 30 includes a first timer 30.1.1. Actuation of light source 22 starts the first timer 30.1.1. When a first, five-minute period of time stored in memory 30.2 has elapsed, light source 22 is automatically deactivated. However, if a control element of the group second control elements 6 is actuated by the user in the meantime, i.e., during the first period of time, then the first deactivation condition is satisfied, and first timer 30.1.1 is automatically stopped. Once the first deactivation condition is satisfied, a second timer 30.1.2 of processing unit 30.1 is started, and a second, thirty-minute period of time stored in memory 30.2 begins to run. After this second period of time has elapsed, second timer 30.1.2 is stopped and light source 22 is deactivated.

In another possible embodiment of the control panel according to the present invention, different illumination modes for illuminating the ten-digit keypad 6 are stored in memory 30.2 and can be selected and activated by processing unit 30.1 in accordance with the actuated first control element 4 or a program which is stored in memory 30.2 and can be invoked by means of processing unit 30.1 for the operation of the household appliance. The different illumination modes may include, for example, different colors of the backlight illumination of ten-digit keypad 6, said different colors being producible by LED's of different color of light source 22. In this manner, the overall aesthetic appearance and the ease of use are further improved.

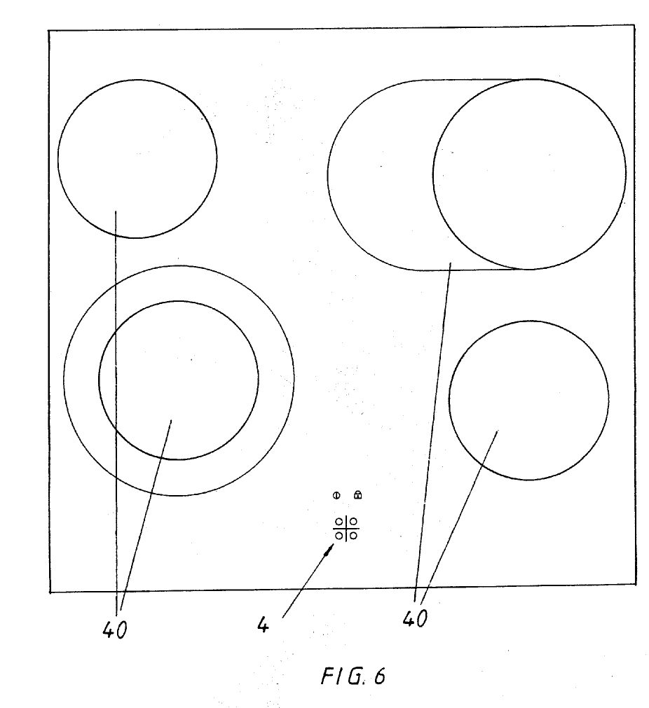

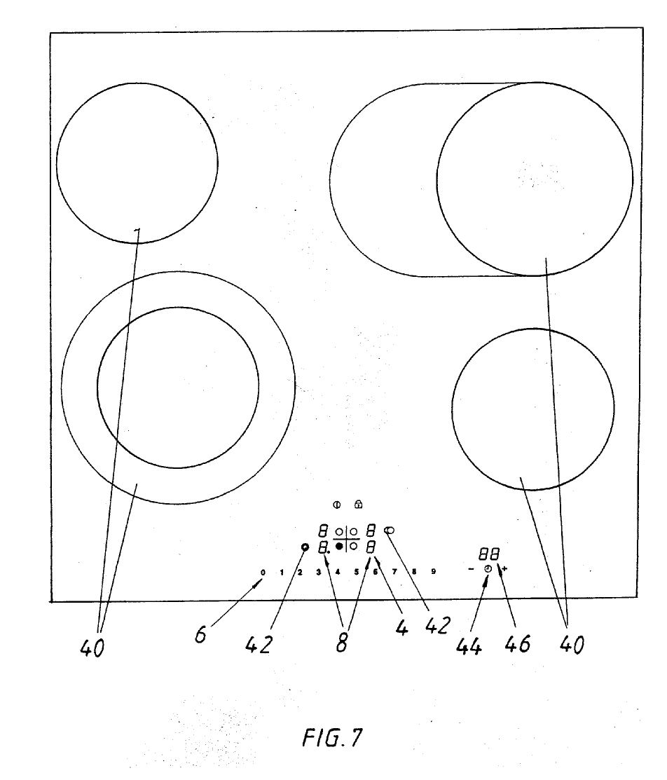

A second exemplary embodiment of the present invention will be explained below in more detail with reference to FIGS. 6 and 7, the following explanations discussing only the aspects that differ from the exemplary embodiment described above.

FIG. 6 shows a stand-alone cooktop having a control panel according to the present invention. The cooktop is in the form of a glass-ceramic plate and has four cooking zones 40, of which two cooking zones 40 are divided into two sections, so that the surface area of these cooking zones 40 can optionally be increased. These cooking zones 40 shown at the bottom left and top right in the image plane. The glass-ceramic plate has no perforations. The group of first control elements 4 are touch-sensitive keys, which are marked on the cooktop analogously to the first embodiment, so that the position of the group of first control elements 4 is perceptible to the human eye, even when the cooktop is off. Each cooking zone 40 has associated therewith a control element of the group of first control elements, said first control elements being arranged on the cooktop in accordance with the arrangement of cooking zones 40. The group of second control elements 6 is configured analogously to the first exemplary embodiment, and is invisible to the human eye as long as no settings need to be made via the group of second control elements 6. If the user now presses one of the control elements of the first group of control elements 4, thereby selecting one of cooking zones 40 for user settings, the group of second control elements 6 is backlit analogously to the first exemplary embodiment, and thus made visible to the human eye on the cooktop (see FIG. 7).

As shown in FIG. 7, the control element of the group of first control elements 4 which control element has been pressed is the one at the bottom left in the image plane. In the present exemplary embodiment, the actuated first control element 4 is backlit for identification purposes, which is symbolized in FIG. 7 by the circular cooking zone symbol being filled in black. Actuation of this one control element 4 firstly causes the heating power level setting for each of the cooking zones 40 to be displayed on displays 8 located next to the individual control elements of the first group of control elements 4. Displays 8 are in the form of seven-segment displays. In the present case, an “8” is displayed for each cooking zone, which corresponds to the second highest heating power level. Secondly, symbols 42, which are provided for the two cooking zones 40 of adjustable surface area and have so far been invisible to the human eye, are backlit in the manner explained hereinabove, and are thus perceptible to the human eye. Symbols 42 indicate the positions of touch-sensitive keys. For example, if the user wishes to enlarge the cooking zone 40 shown at the bottom left in the image plane from the smaller default surface area to the larger surface area, he/she presses the symbol 42 shown at the bottom left in the image plane. The user can then set the desired heating power level for the selected cooking zone 40 by using the group of second control elements 6 analogously to the first exemplary embodiment. In this connection, the digits “0” through “9” represent the selectable heating power levels. Pressing the digit “0” deactivates the heating of the selected cooking zone 40. In the present exemplary embodiment, the user may choose to activate heating timer 44, which is illuminated simultaneously with, and analogously to, the group of second control elements 6. In this case, the user must actuate the now visible “−+” keys of heating timer 44 to thereby set the desired heating time for the selected cooking zone 40. The set heating time is displayed on a display 46 associated with heating timer 44.

The selection made to enter user settings for the other cooking zones 40 and the entry of said settings are carried out analogously. In the aforementioned exemplary embodiment, the settings for a cooking zone 40 can be made only after the desired cooking zone 40 has been selected via the group of first control elements 4.

1-8. (canceled)

9. A control panel for controlling a household appliance, the control panel comprising:
a housing;
an electric or electronic controller disposed in the housing and including a processing unit and a memory;
a first control element disposed on the housing and electrically connected to the controller;
a second control element disposed on the housing and electrically connected to the controller, the second control element including a ten-digit keypad; and
a light source activatable by the first control element and configured to illuminate the keypad in accordance with a predetermined activation condition stored in the memory, the light source being electrically connected to the controller;
wherein when the light source is deactivated, the keypad and light source are substantially invisible to the human eye.

10. The control panel as recited in claim 9 wherein the light source is configured to illuminate the keypad as backlight illumination.

11. The control panel as recited in claim 9 wherein the memory is configured to store a plurality of different illumination modes for illuminating the ten-digit keypad, each of the respective different illumination modes being selectable and activatable by the processing unit in accordance with at least one of the first control element and a program stored in the memory, the program being accessible by the processing unit for operation of the household appliance.

12. The control panel as recited in claim 10 wherein the memory is configured to store a plurality of different illumination modes for illuminating the ten-digit keypad, each of the respective different illumination modes being selectable and activatable by the processing unit in accordance with at least one of the first control element and a program stored in the memory, the program being accessible by the processing unit for operation of the household appliance.

13. The control panel as recited in claim 11 wherein the light source includes a plurality of light-emitting diodes configured to provide the different illumination modes.

14. The control panel as recited in claim 12 wherein the light source includes a plurality of light-emitting diodes configured to provide the different illumination modes.

15. The control panel as recited in claim 9 wherein the processing unit includes a first timer activatable by an activation of the light source and configured to automatically deactivate the light source after an elapsing of a predetermined first period of time stored in the memory.

16. The control panel as recited in claim 15 wherein the first timer is configured to be deactivated in accordance with a predetermined first deactivation condition stored in the memory.

17. The control panel as recited in claim 16 wherein the processing unit includes a second timer activatable when the first deactivation condition is satisfied and configured to automatically deactivate the light source after an elapsing of a predetermined second period of time stored in the memory.

18. The control panel as recited in claim 9 wherein the housing is disposed on the household appliance.
